(19) United States
(12) Patent Application Publication
(10) Pub. No.: US 2012/0163893 A1
(43) Pub. Date: Jun. 28, 2012

(54) FOLDABLE KEYBOARD

(76) Inventor: Chia-Hung Liu, Taoyuan (TW)

(21) Appl. No.: 13/237,988

(22) Filed: Sep. 21, 2011

(30) Foreign Application Priority Data
Dec. 28, 2010 (TW) 099146231

(51) Int. Cl. B41J 5/10

(52) U.S. Cl. 400/489

(57) ABSTRACT

A foldable keyboard includes a supporting plate, a first keyboard module, a second keyboard module, a first slot, a first protrusion, a second slot and a second protrusion. The first and second keyboard modules are disposed on the supporting plate. The second keyboard module is pivotally connected to the first keyboard module. The first slot is selectively disposed on one of the supporting plate and the first keyboard module. The first protrusion corresponding to the first slot is selectively disposed on the other one of the supporting plate and the first keyboard module and movably engaged in the first slot. The second slot is selectively disposed on one of the supporting plate and the second keyboard module. The second protrusion corresponding to the second slot is selectively disposed on the other one of the supporting plate and the second keyboard module and movably engaged in the second slot.

### BACKGROUND OF THE INVENTION

1. Field of the Invention

The invention relates to a keyboard and, more particularly, to a foldable keyboard.

2. Description of the Prior Art

As technology advances and consumer behavior changes, electronic devices (e.g. notebook, tablet personal computer, etc.) have become more and more lighter, thinner, shorter, and smaller. Since the size of electronic device has been miniaturized, a keyboard installed on the electronic device also has to be miniaturized correspondingly. The prior art is to reduce the size of each keyswitch of the keyboard so as to reduce the size of the keyboard, such that the keyboard can be adapted to miniaturized electronic device. However, since the size of each keyswitch of the miniaturized keyboard has been reduced, a user is easy to mis-touch other keyswitches and then make typos. Furthermore, the inner space of the miniaturized keyboard also gets small such that the keyswitches cannot be assembled on the miniaturized keyboard well. As a result, the manufacture cost increases.

### SUMMARY OF THE INVENTION

Therefore, an objective of the invention is to provide a foldable keyboard so as to solve the aforesaid problems.

According to an embodiment, a foldable keyboard of the invention comprises a supporting plate, a first keyboard module, a second keyboard module, a first slot, a first protrusion, a second slot and a second protrusion. The first and second keyboard modules are disposed on the supporting plate. The second keyboard module is pivotally connected to the first keyboard module. The first slot is selectively disposed on one of the supporting plate and the first keyboard module. The first protrusion, which is corresponding to the first slot, is selectively disposed on the other one of the supporting plate and the first keyboard module and movably engaged in the first slot. The second slot is selectively disposed on one of the supporting plate and the second keyboard module. The second protrusion, which is corresponding to the second slot, is selectively disposed on the other one of the supporting plate and the second keyboard module and movably engaged in the second slot. When the first keyboard module and the second keyboard module rotates with respect to each other, the first protrusion and the second protrusion rotate and move within the first slot and the second slot respectively, such that the first keyboard module and the second keyboard module can be folded or expanded with respect to each other on the supporting plate.

According to another embodiment, a foldable keyboard of the invention comprises a supporting plate, a first keyboard module, a second keyboard module, a slot and a protrusion. The supporting plate has a first pivoting portion. The first keyboard module and the second keyboard module are disposed on the supporting plate. The second keyboard module is pivotally connected to the first keyboard module. The second keyboard module has a second pivoting portion pivotally connected to the first pivoting portion. The slot is selectively disposed on one of the supporting plate and the first keyboard module. The protrusion, which is corresponding to the slot, is selectively disposed on the other one of the supporting plate and the first keyboard module and movably engaged in the slot. When the first keyboard module and the second keyboard module rotate with respect to each other, the protrusion rotates and moves within the slot and the second pivoting portion rotates with respect to the first pivoting portion, such that the first keyboard module and the second keyboard module can be folded or expanded with respect to each other on the supporting plate.

As mentioned in the above, the invention may dispose slots and protrusions on the first keyboard module, the second keyboard module and the supporting plate respectively or, alternatively, dispose slot and protrusion on the first keyboard module and the supporting plate respectively and dispose pivoting portions on the second keyboard module and the supporting plate respectively. Accordingly, the first and second keyboard modules, which are pivotally connected to each other, can move along specific path so as to be folded or expanded on the supporting plate. When the first keyboard module and the second keyboard module are folded with respect to each other on the supporting plate, the foldable keyboard of the invention can be stored in a small size. On the other hand, when the first keyboard module and the second keyboard module are expanded with respect to each other on the supporting plate, the foldable keyboard of the invention can provide keyswitches with big size for a user to operate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1(A) is a top view illustrating an expanded state of a foldable keyboard according to an embodiment of the invention, and FIG. 1(B) is a bottom view illustrating the foldable keyboard shown in FIG. 1(A).

FIG. 2(A) is a cross-sectional view illustrating the foldable keyboard shown in FIG. 1(B) along line X-X, and FIG. 2(B) is a cross-sectional view illustrating the foldable keyboard shown in FIG. 1(B) along line Y-Y.

FIG. 3(A) is a top view illustrating the foldable keyboard shown in FIG. 1(A) while being folded, and FIG. 3(B) is a bottom view illustrating the foldable keyboard shown in FIG. 3(A).

FIG. 4(A) is a top view illustrating a folded state of the foldable keyboard shown in FIG. 1(A), and FIG. 4(B) is a bottom view illustrating the foldable keyboard shown in FIG. 4(A).

FIG. 5 is a perspective view illustrating the foldable keyboard shown in FIG. 4 being disposed on a protective cover.

FIG. 6 is a side view illustrating the foldable keyboard shown in FIG. 4 being accommodated in the protective cover.

FIG. 7(A) is a top view illustrating an expanded state of a foldable keyboard according to another embodiment of the invention, and FIG. 7(B) is a bottom view illustrating the foldable keyboard shown in FIG. 7(A).

FIG. 8 is an exploded view illustrating parts of the foldable keyboard shown in FIG. 7.

FIG. 9(A) is a top view illustrating the foldable keyboard shown in FIG. 7(A) while being folded, and FIG. 9(B) is a bottom view illustrating the foldable keyboard shown in FIG. 9(A).

FIG. 10(A) is a top view illustrating a folded state of the foldable keyboard shown in FIG. 7(A), and FIG. 10(B) is a bottom view illustrating the foldable keyboard shown in FIG. 10(A).

FIG. 11 is a perspective view illustrating the foldable keyboard shown in FIG. 10 being disposed on a protective cover.

FIG. 12 is a side view illustrating the foldable keyboard shown in FIG. 10 being accommodated in the protective cover.

### DETAILED DESCRIPTION

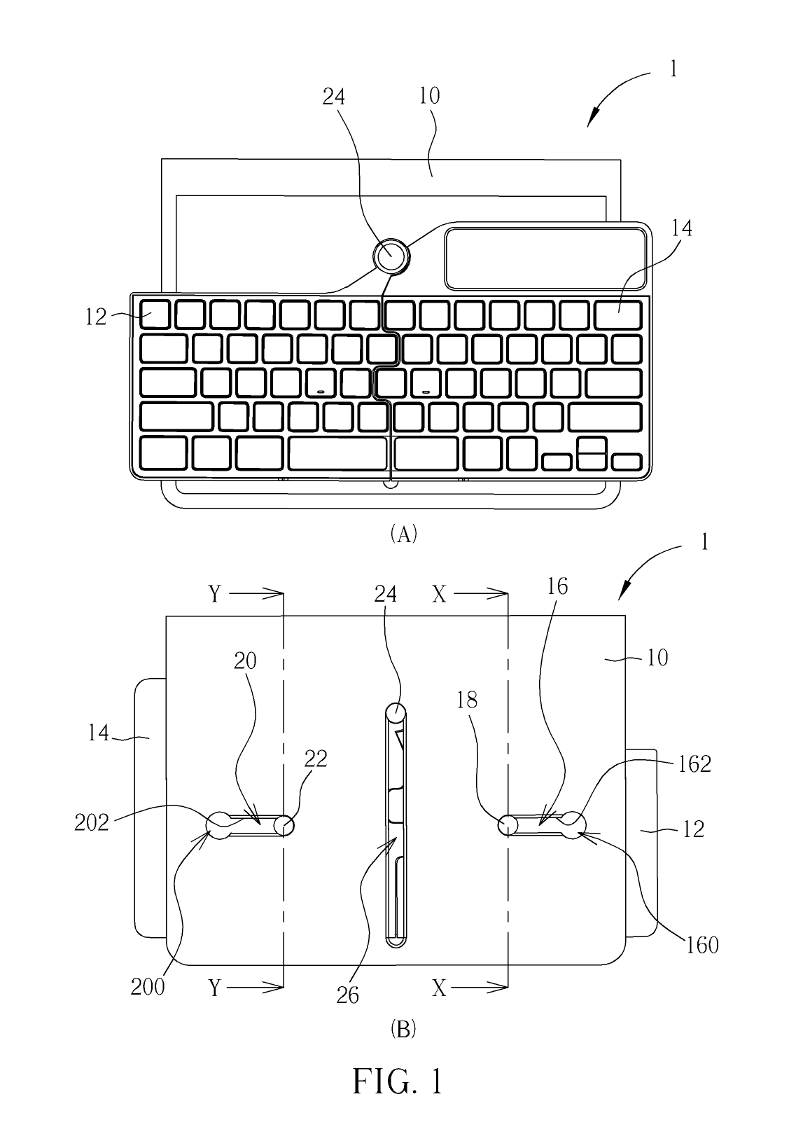

Referring to FIG. 1, FIG. 1(A) is a top view illustrating an expanded state of a foldable keyboard 1 according to an embodiment of the invention, and FIG. 1(B) is a bottom view illustrating the foldable keyboard 1 shown in FIG. 1(A). As shown in FIG. 1, the foldable keyboard 1 comprises a supporting plate 10, a first keyboard module 12, a second keyboard module 14, a first slot 16, a first protrusion 18, a second slot 20, a second protrusion 22 and a pivoting member 24. The first keyboard module 12 and the second keyboard module 14 are disposed on the supporting plate 10. The first keyboard module 12 is pivotally connected to the second keyboard module 14 by the pivoting member 24, such that the first keyboard module 12 and the second keyboard module 14 can rotate with respect to each other.

The first slot 16 can be selectively disposed on one of the supporting plate 10 and the first keyboard module 12 and the first protrusion 18, which is corresponding to the first slot 16, can be selectively disposed on the other one of the supporting plate 10 and the first keyboard module 12. The second slot 20 can be selectively disposed on one of the supporting plate 10 and the second keyboard module 14 and the second protrusion 22, which is corresponding to the second slot 20, can be selectively disposed on the other one of the supporting plate 10 and the second keyboard module 14.

In this embodiment, the first slot 16 is disposed on the supporting plate 10 and the first protrusion 18, which is corresponding to the first slot 16, is disposed on the first keyboard module 12; the second slot 20 is disposed on the supporting plate 10 and the second protrusion 22, which is corresponding to the second slot 20, is disposed on the second keyboard module 14, as shown in FIG. 1(B). However, in another embodiment, the first slot 16 may be disposed on the first keyboard module 12 and the first protrusion 18, which is corresponding to the first slot 16, may be disposed on the supporting plate 10; the second slot 20 may be disposed on the second keyboard module 14 and the second protrusion 22, which is corresponding to the second slot 20, may be disposed on the supporting plate 10. In other words, the configurations of the first slot 16, the first protrusion 18, the second slot 20 and the second protrusion 22 can be determined according to practical applications and are not limited to the embodiment shown in FIG. 1(B).

When the first keyboard module 12 and the second keyboard module 14 are disposed on the supporting plate 10, the first protrusion 18 is movably and rotatably engaged in the first slot 16 and the second protrusion 22 is movably and rotatably engaged in the second slot 22. When the first keyboard module 12 and the second keyboard module 14 rotate with respect to the pivoting member 24, the first protrusion 18 and the second protrusion 22 can only rotate and move within the first slot 16 and the second slot 20 respectively, such that the first keyboard module 12 and the second keyboard module 14 can be folded or expanded with respect to each other on the supporting plate 10.

In this embodiment, the supporting plate 10 has a third slot 26. As shown in FIG. 1(B), the third slot 26 is between the first slot 16 and the second slot 20 and one end of the pivoting member 24 is movably disposed in the third slot 26. Furthermore, an orientation of the first slot 16 is parallel to an orientation of the second slot 20, and an orientation of the third slot 26 is perpendicular to the orientations of the first slot 16 and the second slot 20. When the first keyboard module 12 and the second keyboard module 14 are folded or expanded with respect to each other on the supporting plate 10, the third slot 26 allows one end of the pivoting member 24 to move therein back and forth. Accordingly, the first keyboard module 12 and the second keyboard module 14 can be folded or expanded more stably due to the cooperation between the third slot 26 and the pivoting member 24.

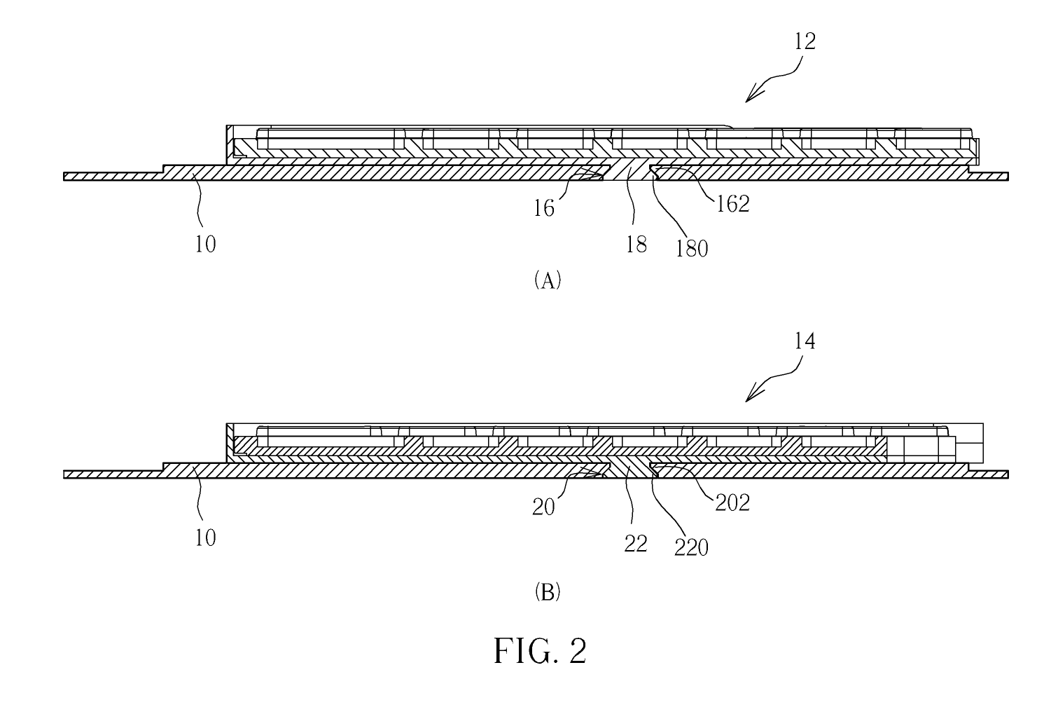

Referring to FIG. 2 along with FIG. 1, FIG. 2(A) is a cross-sectional view illustrating the foldable keyboard 1 shown in FIG. 1(B) along line X-X, and FIG. 2(B) is a cross-sectional view illustrating the foldable keyboard 1 shown in FIG. 1(B) along line Y-Y. As shown in FIGS. 1(B) and 2, one end of the first slot 16 has a first assembling hole 160, one end of the second slot 20 has a second assembling hole 200, and a first restraining portion 180 and a second restraining portion 220 protrude from the first protrusion 18 and the second protrusion 22 respectively. The first restraining portion 180 can pass through the first assembling hole 160 and the second restraining portion 220 can pass through the second assembling hole 200. Thus, to assemble the first keyboard module 12 and the second keyboard module 14 on the supporting plate 10, the first restraining portion 180 and the second restraining portion 220 can be inserted into the first assembling hole 160 and the second assembling hole 200 sequentially so as to dispose the first protrusion 18 and the second protrusion 22 in the first slot 16 and the second slot 20 respectively.

Moreover, the first slot 16 and the second slot 20 have a third restraining portion 162 and a fourth restraining portion 202 respectively. The first restraining portion 180 and the second restraining portion 220 can cooperate with the third restraining portion 162 and the fourth restraining portion 202 respectively so as to restrain the first protrusion 18 and the second protrusion 22 from coming off the first slot 16 and the second slot 20. Accordingly, when the first keyboard module 12 and the second keyboard module 14 are being folded or expanded with respect to each other, the aforesaid mechanism can prevent the first protrusion 18 and the second protrusion 22 from coming off the first slot 16 and the second slot 20 respectively.

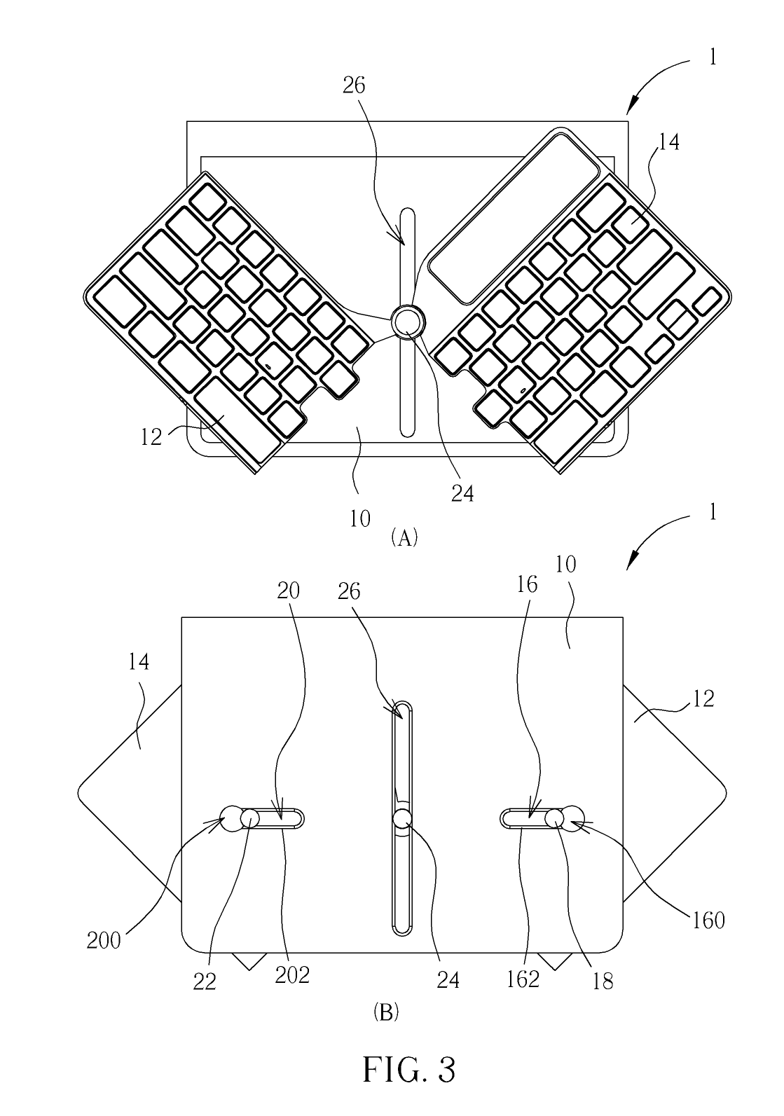

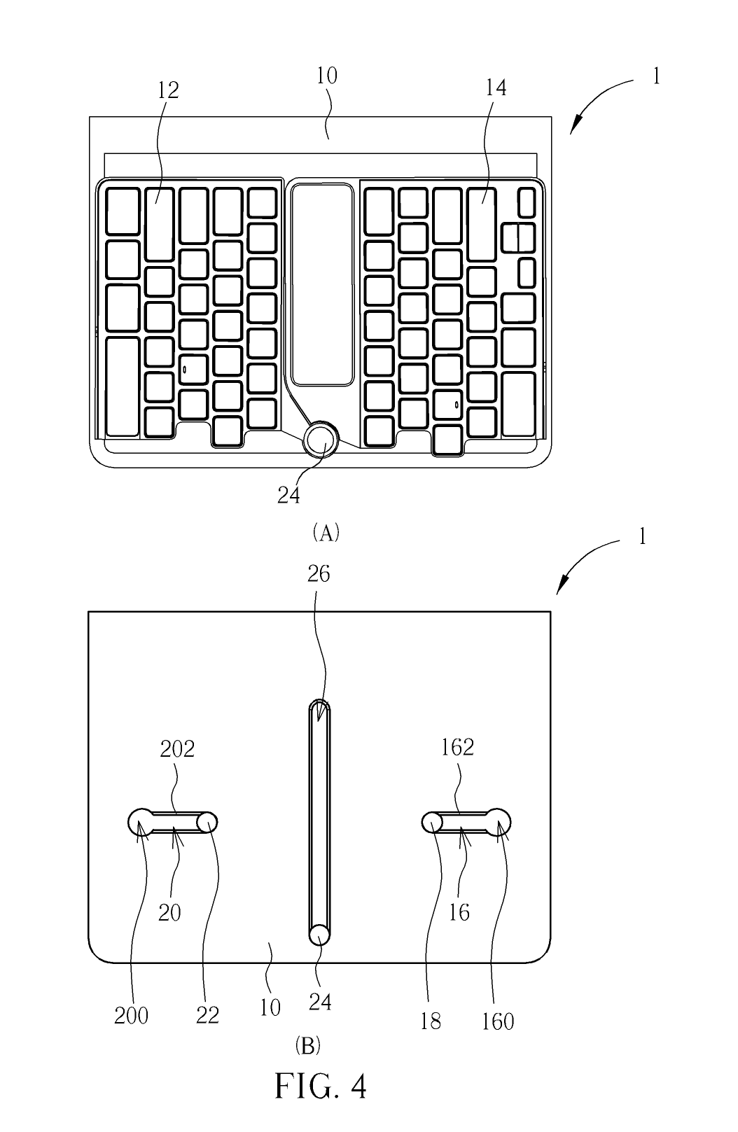

Referring to FIGS. 3 and 4, FIG. 3(A) is a top view illustrating the foldable keyboard 1 shown in FIG. 1(A) while being folded, FIG. 3(B) is a bottom view illustrating the foldable keyboard 1 shown in FIG. 3(A), FIG. 4(A) is a top view illustrating a folded state of the foldable keyboard 1 shown in FIG. 1(A), and FIG. 4(B) is a bottom view illustrating the foldable keyboard 1 shown in FIG. 4(A). When a user wants to fold the foldable keyboard 1 shown in FIG. 1, the user can rotate the first keyboard module 12 and the second keyboard module 14, which are pivotally connected to each other by the pivoting member 24, with respect to each other (as shown in FIG. 3) until the first keyboard module 12 and the second keyboard module 14 are folded on the supporting plate 10 (as shown in FIG. 4).

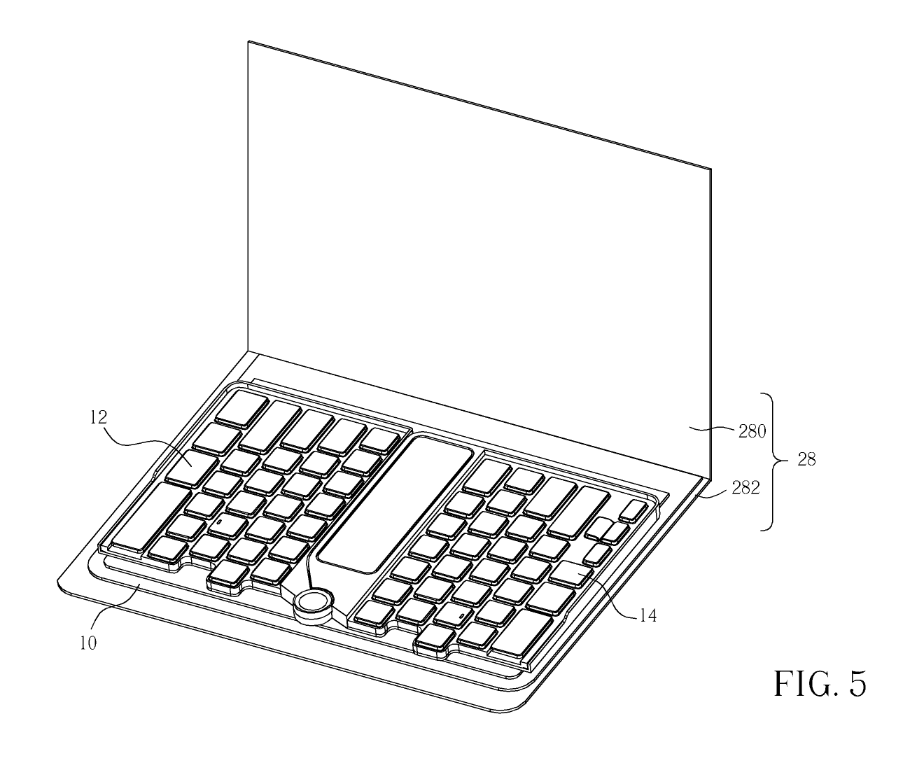

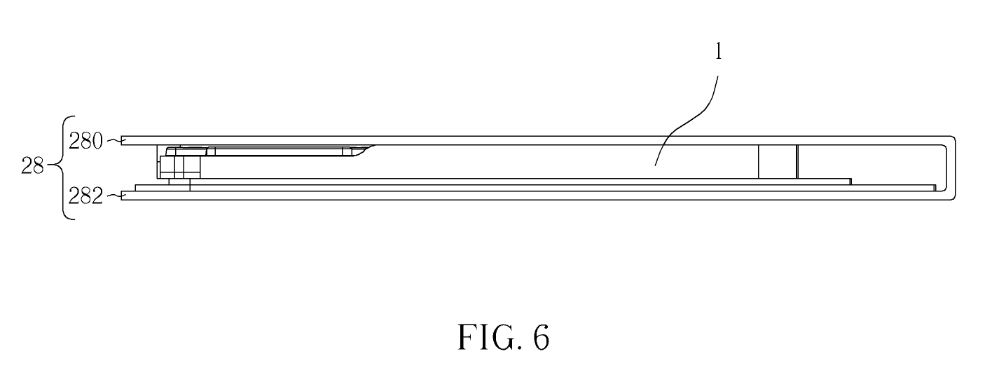

Referring to FIGS. 5 and 6, FIG. 5 is a perspective view illustrating the foldable keyboard 1 shown in FIG. 4 being disposed on a protective cover 28, and FIG. 6 is a side view illustrating the foldable keyboard 1 shown in FIG. 4 being accommodated in the protective cover 28. As shown in FIGS. 5 and 6, the supporting plate 10 of the foldable keyboard 1 can be disposed on a base 282 of a protective cover 18. When the first keyboard module 12 and the second keyboard module 14 are folded with respect to each other on the supporting plate 10 (as shown in FIG. 5), a lid 280 of the protective cover 28 can be folded toward the base 282 so as to store the foldable keyboard 1 in the protective cover 28 (as shown in FIG. 6). Furthermore, when the first keyboard module 12 and the second keyboard module 14 are folded with respect to each other on the supporting plate 10, the first keyboard module 12 and the second keyboard module 14 can be completely located within an area of the supporting plate 10 through appropriate design. Accordingly, the foldable keyboard 1 can be accommodated in the protective cover 28 completely for purpose of transportation. Still further, in practical applications, an electronic device (e.g. tablet personal computer) may be accommodated in the inner side of the lid 280 of the protective cover 28. When a user wants to use the foldable keyboard 1 to operate the electronic device, the user only needs to open the lid 280 of the protective cover 28 and then rotates the first keyboard module 12 and the second keyboard module 14 with respect to each other to be the expanded state shown in FIG. 1.

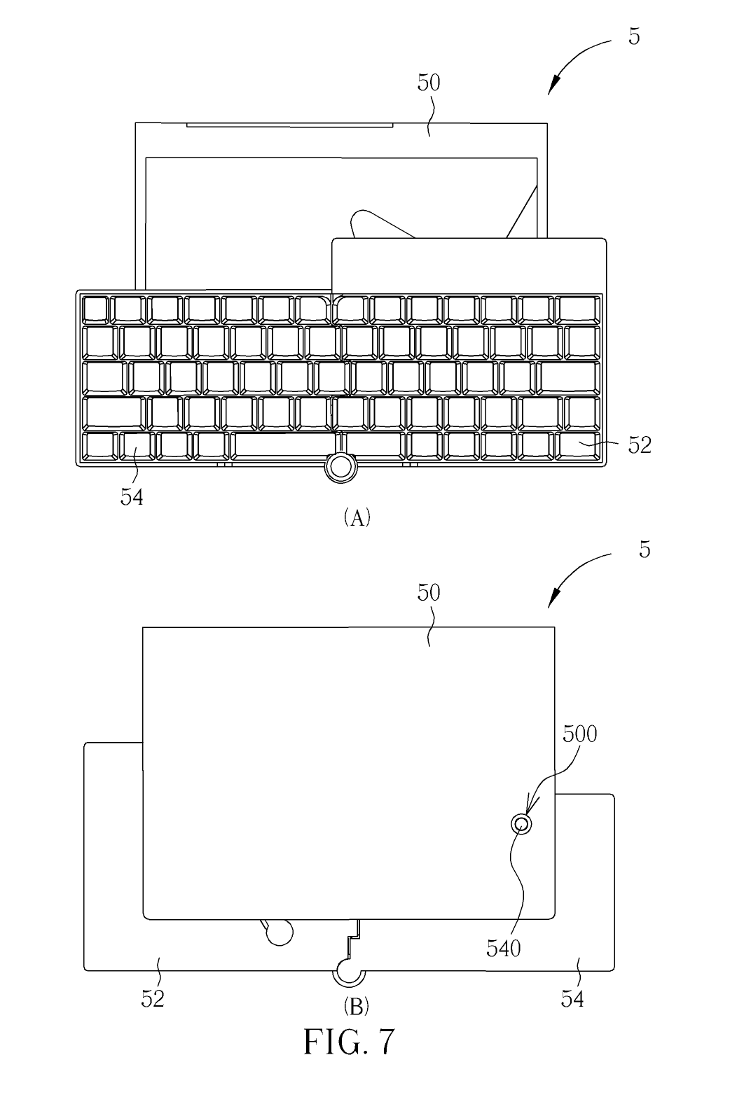

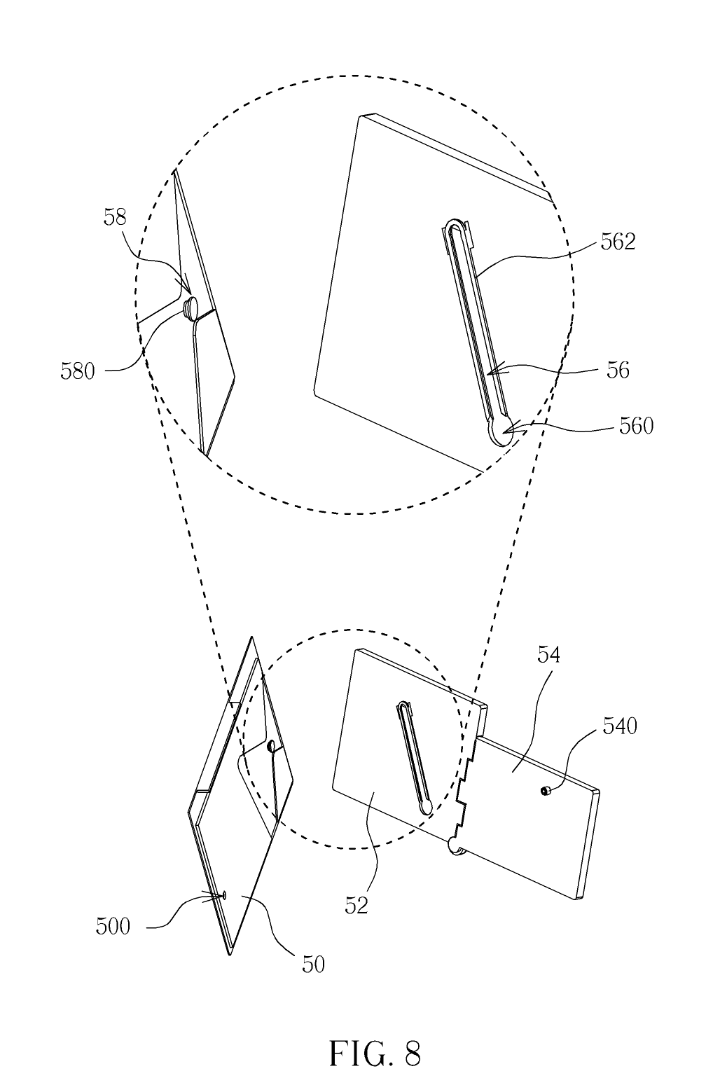

Referring to FIGS. 7 and 8, FIG. 7(A) is a top view illustrating an expanded state of a foldable keyboard 5 according to another embodiment of the invention, FIG. 7(B) is a bottom view illustrating the foldable keyboard 5 shown in FIG. 7(A), and FIG. 8 is an exploded view illustrating parts of the foldable keyboard 5 shown in FIG. 7. As shown in FIGS. 7 and 8, the foldable keyboard 5 comprises a supporting plate 50, a first keyboard module 52, a second keyboard module 54, a slot 56 and a protrusion 58. The first keyboard module 52 and the second keyboard module 54 are disposed on the supporting plate 50. The second keyboard module 54 is pivotally connected to the first keyboard module 52. The supporting plate 50 has a first pivoting portion 500 and the second keyboard module 54 has a second pivoting portion 540 pivotally connected to the first pivoting portion 500. Accordingly, the second keyboard module 54 can rotate with respect to the supporting plate 50.

The slot 56 can be selectively disposed on one of the supporting plate 50 and the first keyboard module 52 and the protrusion 58, which is corresponding to the slot 56, can be selectively disposed on the other one of the supporting plate 50 and the first keyboard module 52. In this embodiment, the slot 56 is disposed on the first keyboard module 52 and the protrusion 58, which is corresponding to the slot 56, is disposed on the supporting plate 50, as shown in FIG. 8. However, in another embodiment, the slot 56 may be disposed on the supporting plate 50 and the protrusion 58, which is corresponding to the slot 56, may be disposed on the first keyboard module 52. In other words, the configurations of the slot 56 and the protrusion 58 can be determined according to practical applications and are not limited to the embodiment shown in FIG. 8.

When the first keyboard module 52 and the second keyboard module 54 are disposed on the supporting plate 50, the protrusion 58 is movably and rotatably engaged in the slot 56 and the first pivoting portion 500 is pivotally connected to the second pivoting portion 540. When the first keyboard module 52 and the second keyboard module 54 rotate with respect to each other, the protrusion 58 can only rotate and move within the slot 56 and the second pivoting portion 540 rotates with respect to the first pivoting portion 500, such that the first keyboard module 52 and the second keyboard module 54 can be folded or expanded with respect to each other on the supporting plate 50.

As shown in FIG. 8, one end of the slot 56 has an assembling hole 560, a first restraining portion 580 protrudes from the protrusion 58, and the first restraining portion 580 can pass through the assembling hole 560. To assemble the first keyboard module 52 and the second keyboard module 54 on the supporting plate 50, first of all, the first restraining portion 580 can be inserted into the assembling hole 560 so as to dispose the protrusion 58 in the slot 56. Afterward, the second pivoting portion 540 can be pivotally connected to the first pivoting portion 500. In this embodiment, the slot 56 may have a second restraining portion 562. The second restraining portion 562 can cooperate with the first restraining portion 580 so as to restrain the protrusion 58 from coming off the slot 56. Accordingly, when the first keyboard module 52 and the second keyboard module 54 are being folded or expanded with respect to each other, the aforesaid mechanism can prevent the protrusion 58 from coming off the slot 56.

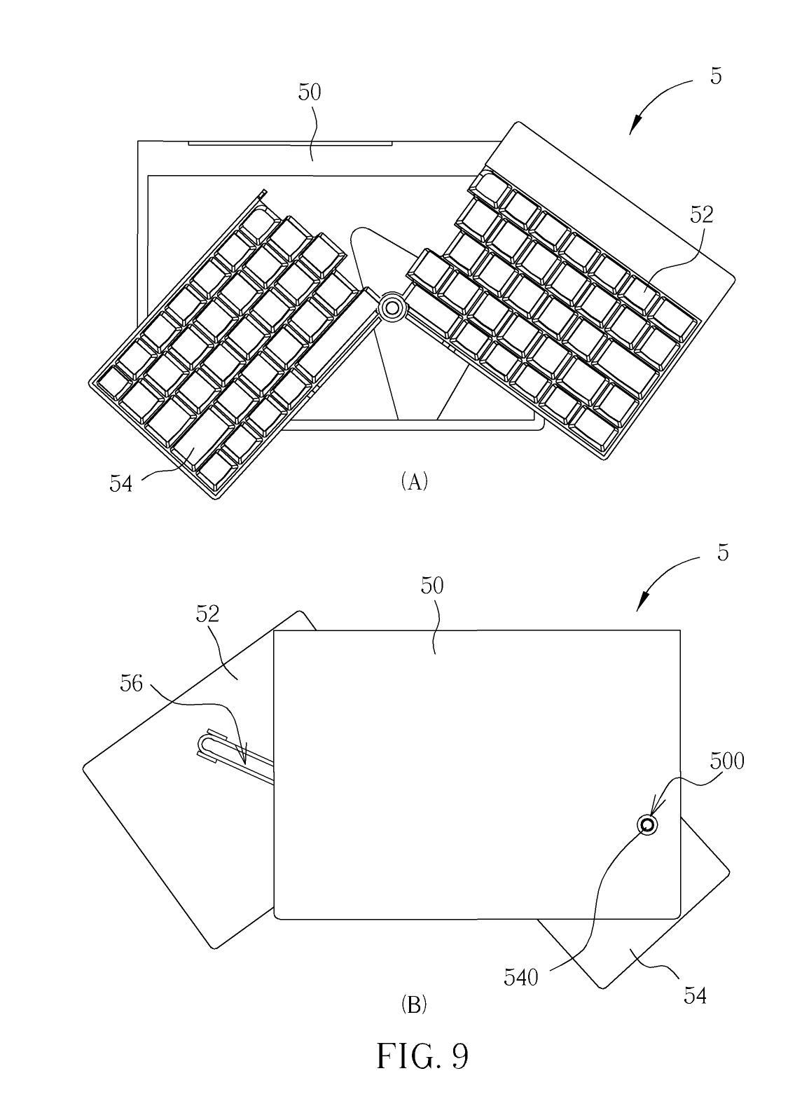

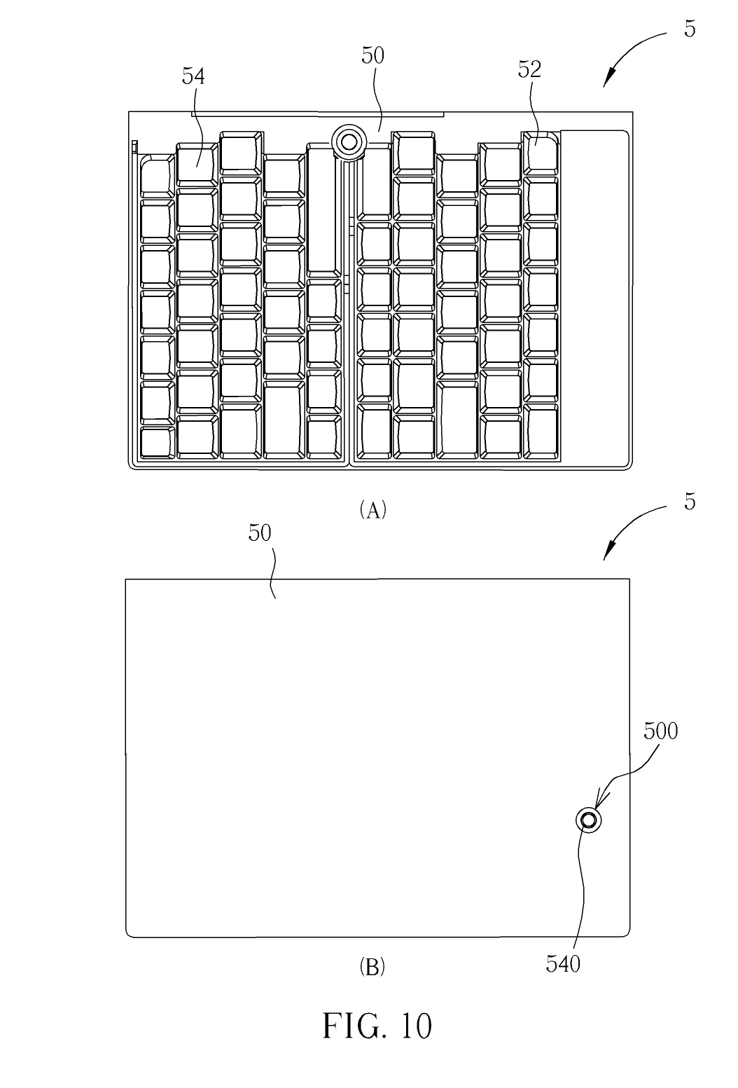

Referring to FIGS. 9 and 10, FIG. 9(A) is a top view illustrating the foldable keyboard 5 shown in FIG. 7(A) while being folded, FIG. 9(B) is a bottom view illustrating the foldable keyboard 5 shown in FIG. 9(A), FIG. 10(A) is a top view illustrating a folded state of the foldable keyboard 5 shown in FIG. 7(A), and FIG. 10(B) is a bottom view illustrating the foldable keyboard 5 shown in FIG. 10(A). When a user wants to fold the foldable keyboard 5 shown in FIG. 7, the user can rotate the first keyboard module 52 and the second keyboard module 54 with respect to each other (as shown in FIG. 9) until the first keyboard module 52 and the second keyboard module 54 are folded on the supporting plate 50 (as shown in FIG. 10).

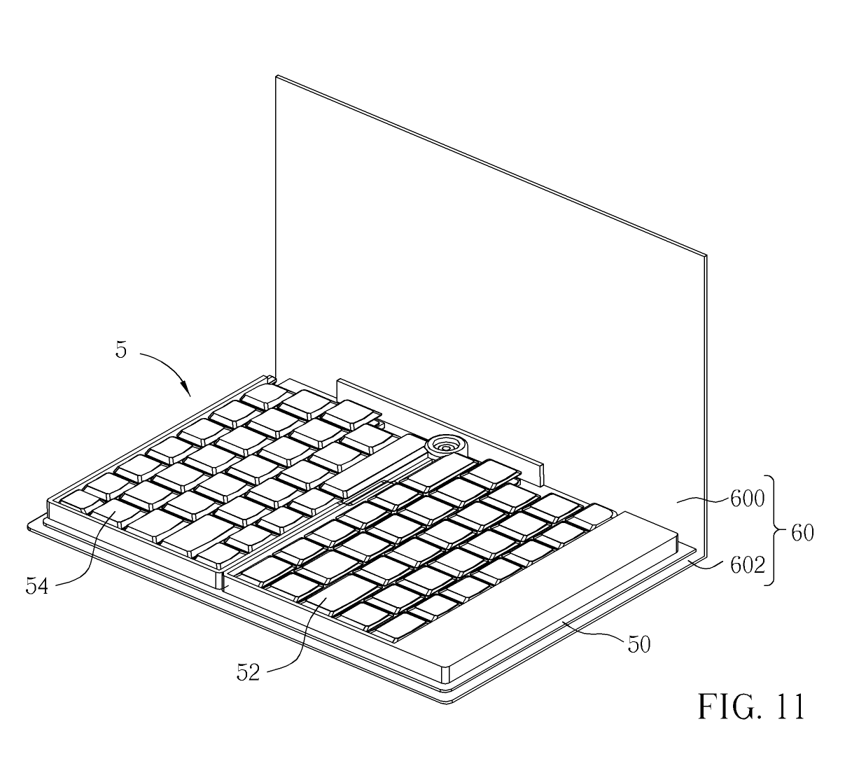

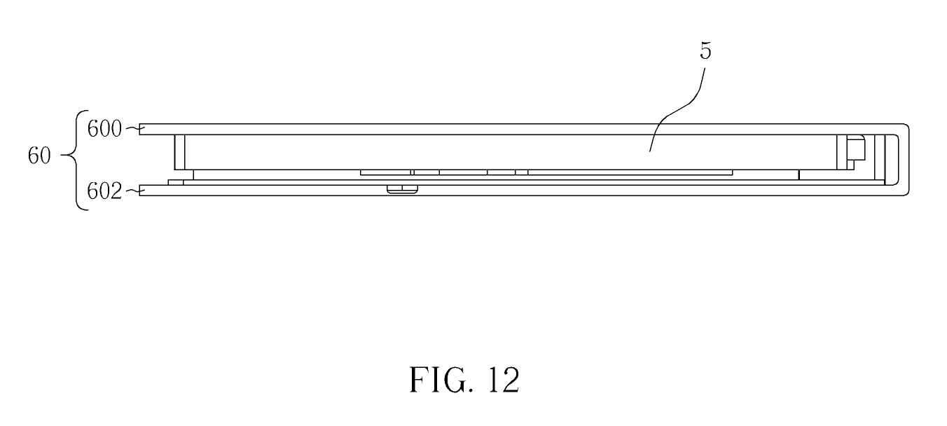

Referring to FIGS. 11 and 12, FIG. 11 is a perspective view illustrating the foldable keyboard 5 shown in FIG. 10 being disposed on a protective cover 60, and FIG. 12 is a side view illustrating the foldable keyboard 5 shown in FIG. 10 being accommodated in the protective cover 60. As shown in FIGS. 11 and 12, the supporting plate 50 of the foldable keyboard 5 can be disposed on a base 602 of a protective cover 60. When the first keyboard module 52 and the second keyboard module 54 are folded with respect to each other on the supporting plate 50 (as shown in FIG. 11), a lid 600 of the protective cover 60 can be folded toward the base 602 so as to store the foldable keyboard 5 in the protective cover 60 (as shown in FIG. 12). Furthermore, when the first keyboard module 52 and the second keyboard module 54 are folded with respect to each other on the supporting plate 50, the first keyboard module 52 and the second keyboard module 54 can be completely located within an area of the supporting plate 50 through appropriate design. Accordingly, the foldable keyboard 5 can be accommodated in the protective cover 60 completely for purpose of transportation. Still further, in practical applications, an electronic device (e.g. tablet personal computer) may be accommodated in the inner side of the lid 600 of the protective cover 60. When a user wants to use the foldable keyboard 5 to operate the electronic device, the user only needs to open the lid 600 of the protective cover 60 and then rotates the first keyboard module 52 and the second keyboard module 54 with respect to each other to be the expanded state shown in FIG. 7.

Compared to the prior art, the invention may dispose slots and protrusions on the first keyboard module, the second keyboard module and the supporting plate respectively or, alternatively, dispose slot and protrusion on the first keyboard module and the supporting plate respectively and dispose pivoting portions on the second keyboard module and the supporting plate respectively. Accordingly, the first and second keyboard modules, which are pivotally connected to each other, can move along specific path so as to be folded or expanded on the supporting plate. When the first keyboard module and the second keyboard module are folded with respect to each other on the supporting plate, the foldable keyboard of the invention can be stored in a small size. On the other hand, when the first keyboard module and the second keyboard module are expanded with respect to each other on the supporting plate, the foldable keyboard of the invention can provide keyswitches with big size for a user to operate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A foldable keyboard comprising:
a supporting plate;
a first keyboard module disposed on the supporting plate;
a second keyboard module disposed on the supporting plate and pivotally connected to the first keyboard module;
a first slot selectively disposed on one of the supporting plate and the first keyboard module;
a first protrusion, which is corresponding to the first slot, selectively disposed on the other one of the supporting plate and the first keyboard module and movably engaged in the first slot;
a second slot selectively disposed on one of the supporting plate and the second keyboard module; and
a second protrusion, which is corresponding to the second slot, selectively disposed on the other one of the supporting plate and the second keyboard module and movably engaged in the second slot;
wherein when the first keyboard module and the second keyboard module rotate with respect to each other, the first protrusion and the second protrusion rotate and move within the first slot and the second slot respectively, such that the first keyboard module and the second keyboard module are folded or expanded with respect to each other on the supporting plate.

2. The foldable keyboard of claim 1, wherein a first restraining portion and a second restraining portion protrude from the first protrusion and the second protrusion respectively, the first slot and the second slot have a third restraining portion and a fourth restraining portion respectively, the first restraining portion and the second restraining portion cooperate with the third restraining portion and the fourth restraining portion respectively so as to restrain the first protrusion and the second protrusion from coming off the first slot and the second slot.

3. The foldable keyboard of claim 2, wherein one end of the first slot has a first assembling hole, the first restraining portion passes through the first assembling hole such that the first protrusion is disposed in the first slot; one end of the second slot has a second assembling hole, the second restraining portion passes through the second assembling hole such that the second protrusion is disposed in the second slot.

4. The foldable keyboard of claim 1, further comprising a pivoting member, wherein the first keyboard module is pivotally connected to the second keyboard module by the pivoting member.

5. The foldable keyboard of claim 4, wherein the supporting plate has a third slot between the first slot and the second slot, and one end of the pivoting member is movably disposed in the third slot.

6. The foldable keyboard of claim 5, wherein an orientation of the first slot is parallel to an orientation of the second slot, and an orientation of the third slot is perpendicular to the orientations of the first and second slots.

7. The foldable keyboard of claim 1, wherein when the first keyboard module and the second keyboard module are folded with respect to each other on the supporting plate, the first keyboard module and the second keyboard module are completely located within an area of the supporting plate.

8. The foldable keyboard of claim. 1, wherein when the first keyboard module and the second keyboard module are folded with respect to each other on the supporting plate, the foldable keyboard is capable of being accommodated in a protective cover.

9. A foldable keyboard comprising:
a supporting plate having a first pivoting portion;
a first keyboard module disposed on the supporting plate;
a second keyboard module disposed on the supporting plate and pivotally connected to the first keyboard module, the second keyboard module having a second pivoting portion pivotally connected to the first pivoting portion;
a slot selectively disposed on one of the supporting plate and the first keyboard module; and
a protrusion, which is corresponding to the slot, selectively disposed on the other one of the supporting plate and the first keyboard module and movably engaged in the slot;
wherein when the first keyboard module and the second keyboard module rotate with respect to each other, the protrusion rotates and moves within the slot and the second pivoting portion rotates with respect to the first pivoting portion, such that the first keyboard module and the second keyboard module are folded or expanded with respect to each other on the supporting plate.

10. The foldable keyboard of claim 9, wherein a first restraining portion protrudes from the protrusion, the slot has a second restraining portion, the first restraining portion cooperates with the second restraining portion so as to restrain the protrusion from coming off the slot.

11. The foldable keyboard of claim 10, wherein one end of the slot has an assembling hole, the first restraining portion passes through the assembling hole such that the protrusion is disposed in the slot.

12. The foldable keyboard of claim 9, wherein when the first keyboard module and the second keyboard module are folded with respect to each other on the supporting plate, the first keyboard module and the second keyboard module are completely located within an area of the supporting plate.

13. The foldable keyboard of claim 9, wherein when the first keyboard module and the second keyboard module are folded with respect to each other on the supporting plate, the foldable keyboard is capable of being accommodated in a protective cover.
